(19) United States
(12) Patent Application Publication
(10) Pub. No.: US 2008/0179857 A1
(43) Pub. Date: Jul. 31, 2008

(54) Bicycle front connection assembly

(76) Inventor: Kun-Yuan Li, Taichung (TW)

Correspondence Address: Kun-Yuan Li, 235 Chung-Ho, Box 8-24, Taipei, omitted

(21) Appl. No.: 11/699,725

(22) Filed: Jan. 31, 2007

(51) Int. Cl. B62K 3/02

(52) U.S. Cl. 280/281.1

(57) ABSTRACT

A bicycle front connection assembly comprises an upper round seat having an upper small portion engaged to the front rube; a lower side of the upper large portion having an annular trench having a plurality of balls and being filled with oil; an inner side of the annular trench being a ball round disk having a plurality of grooves each having a steel ball therein; so that the upper round seat can be engaged to the bi-forked tube to form as a bearing; and a lower round seat having a lower large portion at a lower side thereof and a lower small portion at an upper side thereof; a top side of the lower large portion of the lower round seat having a ball round disk; then a lower cover covering an opening of the lower large portion so as to form the structure of the present invention.

### FIELD OF THE INVENTION

The present invention relates to bicycles, and particularly to a bicycle front connection assembly which has a simple structure so that the defects in the prior art is improved.

### BACKGROUND OF THE INVENTION

The bicycle front connection assembly for combining the stand tube, front rube and bi-forked tube has the effect of retaining the balance of a bicycle. The stand tube is connected to the handle of a bicycle and the bi-forked tube is connected to the front wheel of the bicycle. The bicycle front connection assembly is an important assembly to the bicycle. If the assembly of the bicycle front connection assembly is simple, the probability of fault assembly is reduced and the safety of the bicycle is increased.

Referring to FIG. 1, in the prior art bicycle front connection assembly, the upper round seat 91 and the lower round seat 92 are installed to the two ends of the front rube 90 for being connected to a bi-forked tube. Then the steel balls and ball round disks are assembled to the upper round seat 91 and lower round seat 92. The upper plug 92 and lower plug 95 are used to seal the water proof rings 96 and sleeves 97. Then the upper round seat 91 will seal the upper cover 98.

The prior art structure is very complicated. The elements of the bicycle front connection assembly are assembled one by one so that efficiency is low and the labor cost is high. Furthermore the maintenance is tedious. As a whole, it is not practicable.

### SUMMARY OF THE INVENTION

Accordingly, the primary object of the present invention is to provide a bicycle front connection assembly which has a simple structure so that the defects in the prior art is improved.

To achieve above objects, the present invention provides a bicycle front connection assembly which comprises an upper round seat having an upper small portion engaged to the front rube; a lower side of the upper large portion having an annular trench having a plurality of balls and being filled with oil; an inner side of the annular trench being a ball round disk having a plurality of grooves each having a steel ball therein; so that the upper round seat can be engaged to the bi-forked tube so as to form as a bearing; and a lower round seat having a lower large portion at a lower side thereof and a lower small portion at an upper side thereof; a top side of the lower large portion of the lower round seat having a ball round disk; then a lower cover covering an opening of the lower large portion so as to form the structure of the present invention.

The various objects and advantages of the present invention will be more readily understood from the following detailed description when read in conjunction with the appended drawing.

### BRIEF DESCRIPTION OF THE DRAWINGS

FIG. 1 is an exploded cross sectional view of the prior art bicycle front connection assembly of the present invention.

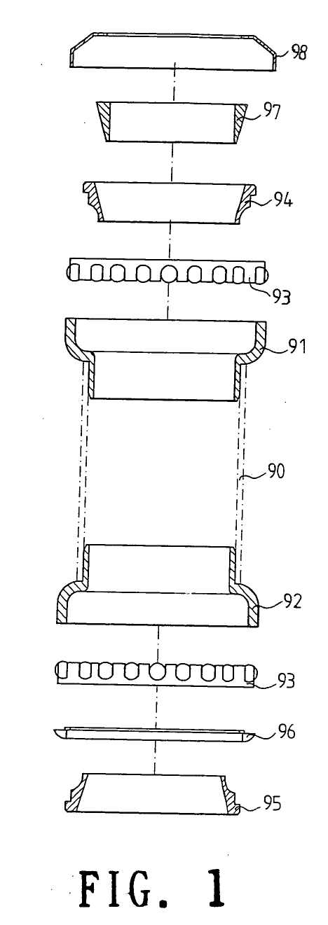

FIG. 2 is an exploded perspective view of the bicycle front connection assembly of the present invention.

FIG. 3 is an exploded cross sectional view of the bicycle front connection assembly of the present invention.

FIG. 4 is an enlarged perspective view of the upper round seat of the bicycle front connection assembly of the present invention.

FIG. 5 is an enlarged perspective view of the lower round seat of the present invention.

FIG. 6 is an assembled perspective view of the bicycle front connection assembly of the present invention.

FIG. 7 is a cross sectional view about the assembly of the bicycle front connection assembly of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

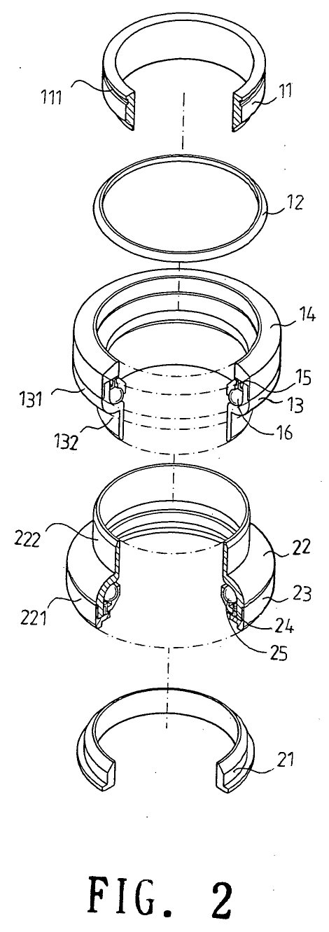

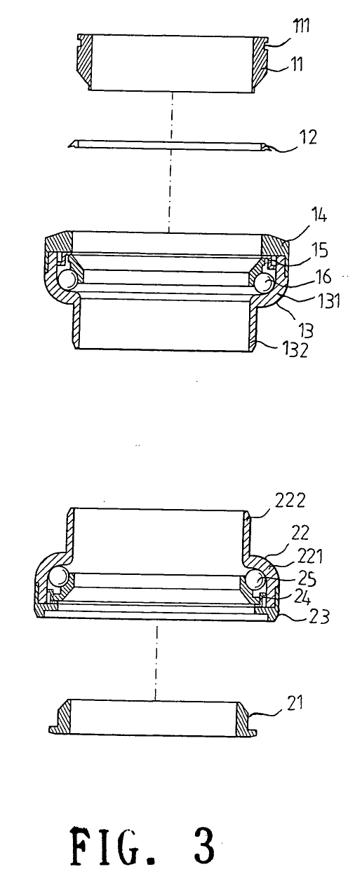

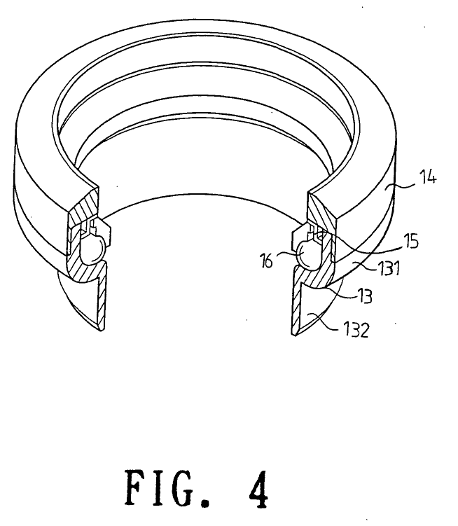

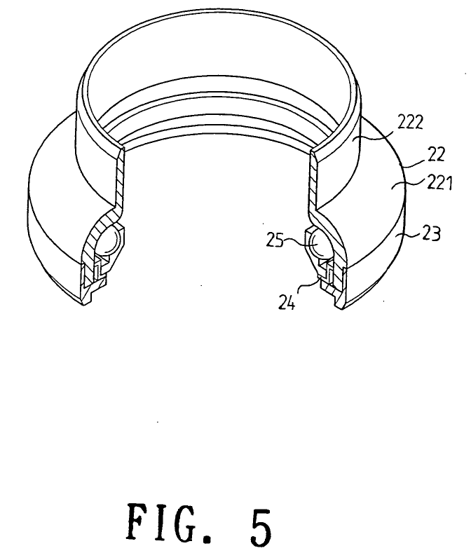

Referring to FIGS. 2 to 5, the bicycle front connection assembly of the present invention is illustrated. The present invention has the following elements.

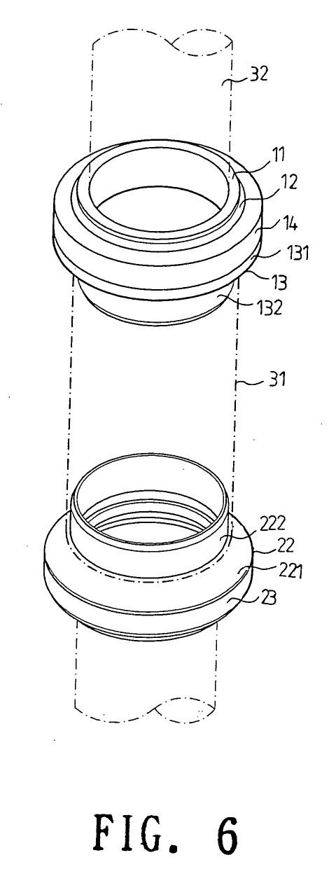

An upper round seat 13 includes an upper large portion 131 and a lower small portion 222 which are formed as a step structure. The upper large portion 131 has a large diameter and a small diameter. The upper large portion 131 has a size corresponding to the interior size of a front rube 31 (FIG. 6) so that the upper small portion 132 can be engaged to the front rube 31. A lower side of the upper large portion 131 has an annular trench 16 having a plurality of balls therein and is filled with oil. An oil seal ring 15 seals an inner side of the annular trench 16 so as to retain the oil in the annular trench 16. Then an upper cover 14 covers an upper side of the annular trench 16 so that the upper round seat 13, the annular trench 16, the oil seal ring 15 and the upper cover 14 are formed as an integral structure.

An inner side of the annular trench 16 is a ball round disk 25 having a plurality of grooves each having a steel ball therein. The size of the inner side of the annular trench 16 is corresponding to an outer diameter of the bi-forked tube 32 of a bicycle (referring to FIG. 6) so that the upper round seat 13 can be engaged to the bi-forked tube 32 so as to form as a bearing. As a result, the bi-forked tube 32 is rotatable.

A sleeve 11 is capable of being engaged to the bi-forked tube 32. A lower side of the sleeve 11 is in contact to the annular trench 16. When the bi-forked tube 32 rotates, the sleeve 11 and annular trench 16 also rotates. An outer side of the sleeve 11 is formed with an annular recess 111 for receiving a water proof ring 12 so as to seal the gap between the upper cover 14 and the sleeve 11.

A lower round seat 22 has a lower large portion 221 at a lower side thereof and a lower small portion 222 at an upper side thereof. The diameter of the lower large portion 221 is greater than that of the lower small portion 222 so that the lower round seat 22 is formed as a stepped structure. The lower small portion 222 of the lower round seat 22 is corresponding an inner diameter of the front rube 31 so that the lower round seat 22 can be engaged to the front rube 31. A top side of the lower large portion 221 of the lower round seat 22 has a ball round disk 25. An oil seal ring 24 seals a lower side of the ball round disk 25 of the lower round seat 22 for sealing the lubricated oil therein. Then a lower cover 23 covers an opening of the lower large portion 221 so that the ball round disk 25 and the oil seal ring 24 are confined in the lower large portion 221 of the lower round seat 22. When the user assemblies a bicycle, the lower round seat 22, ball round disk 25, oil seal ring 24 and the lower cover 23 are formed as an integral structure.

The ball round disk 25 of the lower round seat 22 has a plurality of grooves and steel balls in the grooves. The ball round disk 25 are engaged to the top end of the lower large portion 221 of the lower round seat 22. An inner diameter of the ball round disk 25 is corresponding to the outer diameter of the bi-forked tube 32 of a bicycle so that it can be assembled thereto as a rotatable bearing. The bi-forked tube 32 is rotatable.

A lower plug 21 can be engaged to the bi-forked tube 32. An upper end of the lower cover 23 is in contact to the ball round disk 25. When the bi-forked tube 32 rotates, the lower plug 21 and ball round disk 25 also rotates. An outer side of the lower plug 21 is slightly smaller than the inner diameter of the lower cover 23 for preventing undesired objects to enter thereto.

In the present invention, the annular trench 16 and oil seal ring 15 are assembled to the upper round seat 13 and then are cover by the upper cover 14 so as to form as an integral structure, and the ball round disk 25 and oil seal ring 24 are assembled to the lower round seat 22 and then are covered by the lower cover 23 so as to form an integral structure.

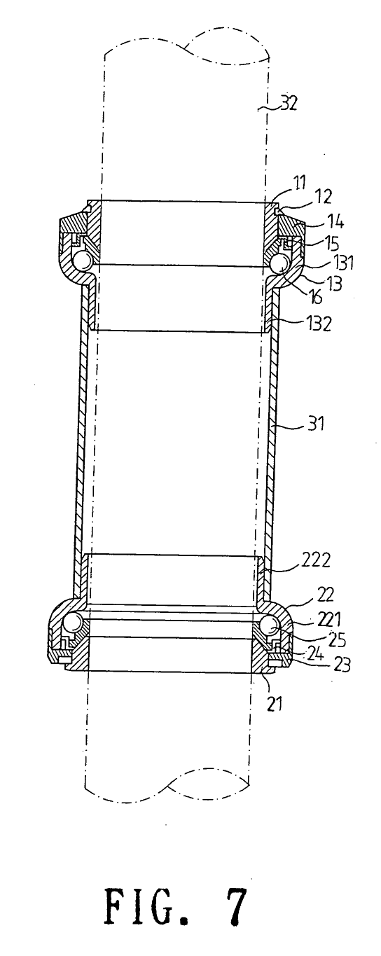

Referring to FIGS. 6 and 7, the assembly of the present invention is illustrated. The outer frame 25 and lower round seat 22 are engaged to the bi-forked tube 32 so that the lower round seat 22 is combined to the lower plug 21 and the lower plug 21 and the ball round disk 25 of the lower round seat 22 are interacted with the bi-forked tube 32. The ball round disk 25 is as a bearing as the bi-forked tube 32 rotates. Then the lower small portion 222 of the lower round seat 22 is tightly engaged with the lower end of the front rube 31. The upper small portion 132 of the upper round seat 13 is tightly engaged to the front rube 31. The annular trench 16 of the upper round seat 13 is as a bearing of the bi-forked tube 32. Finally, the waterproof ring 12 buckles in the annular recess 111 of the sleeve 11. Then the sleeve 11 is engaged to the bi-forked tube 32 so as to seal the gap between the upper cover 14 and the sleeve 11. Therefore, the assembly of the present invention is complete.

In the present invention, the upper cover 14 of the upper round seat 13 and the lower cover 23 of the lower round seat 22 are not adhered to the bi-forked tube 32 so that they are not driven by the bi-forked tube 32. Thus the tightness and sealing of structure are increased. No undesired object will enter thereinto.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bicycle front connection assembly comprising:
an upper round seat including an upper large portion and a lower small portion which are formed as a step structure; the upper large portion having a large diameter and a small diameter; the upper large portion having a size corresponding to an interior size of a front rube so that the upper small portion can be engaged to the front rube; a lower side of the upper large portion having an annular trench having a plurality of balls therein and is filled with oil; an inner side of the annular trench being a ball round disk having a plurality of grooves each having a steel ball therein; a size of the inner side of the annular trench being corresponding to an outer diameter of the bi-forked tube of a bicycle so that the upper round seat can be engaged to the bi-forked tube so as to form as a bearing; as a result, the bi-forked tube is rotatable; a sleeve being engageable to the bi-forked tube; a lower side of the sleeve being in contact to the annular trench; when the bi-forked tube rotates, the sleeve and annular trench also rotates; an outer side of the sleeve being formed with an annular recess for receiving a water proof ring so as to seal the gap between the upper cover and the sleeve; an upper cover covering an upper side of the annular trench; and
a lower round seat having a lower large portion at a lower side thereof and a lower small portion at an upper side thereof; a diameter of the lower large portion being greater than that of the lower small portion so that the lower round seat is formed as a stepped structure; the lower small portion of the lower round seat being corresponding an inner diameter of the front rube so that the lower round seat can be engaged to the front rube; a top side of the lower large portion of the lower round seat having a ball round disk; then a lower cover covering an opening of the lower large portion; a ball round disk of the lower round seat having a plurality of grooves and steel balls in the grooves; the ball round disk being engaged to the top end of the lower large portion of the lower round seat; an inner diameter of the ball round disk being corresponding to the outer diameter of the bi-forked tube of a bicycle so that it can be assembled thereto as a rotatable bearing; the bi-forked tube is rotatable; a lower plug being engaged to the bi-forked tube; an upper end of the lower cover being in contact to the ball round disk; when the bi-forked tube rotates, the lower plug and ball round disk also rotates; an outer side of the lower plug is slightly smaller than the inner diameter of the lower cover for preventing undesired object to enter thereto.

2. The bicycle front connection assembly as claimed in claim 1, further comprising:
an oil seal ring sealing an inner side of the annular trench so as to retain the oil in the annular trench.

3. The bicycle front connection assembly as claimed in claim 1, further comprising an oil seal ring sealing a lower side of the ball round disk of the lower round seat for sealing the lubricated oil therein.

4. The bicycle front connection assembly as claimed in claim 1, wherein the upper round seat is threaded to the upper cover.

5. The bicycle front connection assembly as claimed in claim 1, wherein the lower round seat is threaded to the lower round seat.

6. A bicycle front connection assembly comprising:
an upper round seat including an upper large portion and a lower small portion which are formed as a step structure; the upper large portion having a large diameter and a small diameter; the upper large portion having a size corresponding to an interior size of a front rube so that the upper small portion can be engaged to the front rube; a lower side of the upper large portion having an annular trench having a plurality of balls therein and being filled with oil; an inner side of the annular trench being a ball round disk having a plurality of grooves each having a steel ball therein; a size of the inner side of the annular trench being corresponding to an outer diameter of the bi-forked tube of a bicycle so that the upper round seat can be engaged to the bi-forked tube so as to form as a bearing; as a result, the bi-forked tube is rotatable; a sleeve being engageable to the bi-forked tube; a lower side of the sleeve being in contact to the annular trench; when the bi-forked tube rotates, the sleeve and annular trench also rotates; an outer side of the sleeve being formed with an annular recess for receiving a water proof ring so as to seal the gap between the upper cover and the sleeve; an upper cover covering an upper side of the annular trench.

7. The bicycle front connection assembly as claimed in claim 6, further comprising:
an oil seal ring sealing an inner side of the annular trench so as to retain the oil in the annular trench.

8. The bicycle front connection assembly as claimed in claim 6, wherein the upper round seat is threaded to the upper cover.

9. A bicycle front connection assembly comprising:
a lower round seat having a lower large portion at a lower side thereof and a lower small portion at an upper side thereof; a diameter of the lower large portion being greater than that of the lower small portion so that the lower round seat is formed as a stepped structure; the lower small portion of the lower round seat being corresponding an inner diameter of the front rube so that the lower round seat can be engaged to the front rube; a top side of the lower large portion of the lower round seat having a ball round disk; then a lower cover covering an opening of the lower large portion; a ball round disk of the lower round seat having a plurality of grooves and steel balls in the grooves; the ball round disk being engaged to the top end of the lower large portion of the lower round seat; an inner diameter of the ball round disk being corresponding to the outer diameter of the bi-forked tube of a bicycle so that it can be assembled thereto as a rotatable bearing; the bi-forked tube being rotatable; a lower plug being engaged to the bi-forked tube; an upper end of the lower cover being in contact to the ball round disk; when the bi-forked tube rotates, the lower plug and ball round disk also rotates; an outer side of the lower plug is slightly smaller than the inner diameter of the lower cover for preventing undesired object to enter thereto.

10. The bicycle front connection assembly as claimed in claim 9, further comprising:
an oil seal ring sealing a lower side of the ball round disk of the lower round seat for sealing the lubricated oil therein.

11. The bicycle front connection assembly as claimed in claim 9, wherein the lower round seat is threaded to the lower round seat.
